(19) United States
(12) Patent Application Publication
(10) Pub. No.: US 2014/0189552 A1
(43) Pub. Date: Jul. 3, 2014

(54) ELECTRONIC DEVICES AND METHODS FOR ARRANGING FUNCTIONAL ICONS OF THE ELECTRONIC DEVICE

(71) Applicant: Beijing FUNATE Innovation Technology Co., LTD., Beijing (CN)

(72) Inventors: YU-QUAN WANG, Beijing (CN); LI QIAN, Beijing (CN)

(21) Appl. No.: 13/939,475

(22) Filed: Jul. 11, 2013

(30) Foreign Application Priority Data
Dec. 27, 2012 (CN) 2012105776503

(51) Int. Cl. G06F 3/0481

(52) U.S. Cl. CPC G06F 3/04817
USPC 715/765

(57) ABSTRACT

A portable electronic device having two input units, a processor, a memory and a display unit, allows single handed operation for the repositioning of desktop icons and shortcuts. The input unit includes a touch panel and another sensor and movements of the device are interpreted as commands to rearrange the current display locations of desktop items, for more convenient and personalized operations on the items. A method for arranging the functional icons of the electronic device is also provided.

### RELATED APPLICATIONS

This application claims all benefits accruing under 35 U.S.C. §119 from China Patent Application No. 201210577650.3, filed on Dec. 27, 2012 in the China Intellectual Property Office, the disclosure of which is incorporated herein by reference.

### BACKGROUND

1. Technical Field

The present invention relates to an electronic device and a method for arranging functional icons of the electronic device.

2. Discussion of Related Art

Referring to FIG. 1, a touch panel is usually deployed in a portable electronic device 200 to control the portable electronic device 200.

However, when the portable electronic device 200 is held and operated with one hand of a user, some functional icons of the portable electronic device 200 are difficult to reach with one hand, especially if the electronic device is large size. Thus, the portable electronic device 200 is difficult to use with one hand operation.

What is needed, therefore, is to provide an electronic device and a method for arranging functional icons of the electronic device, which can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an electronic device of prior art in use.

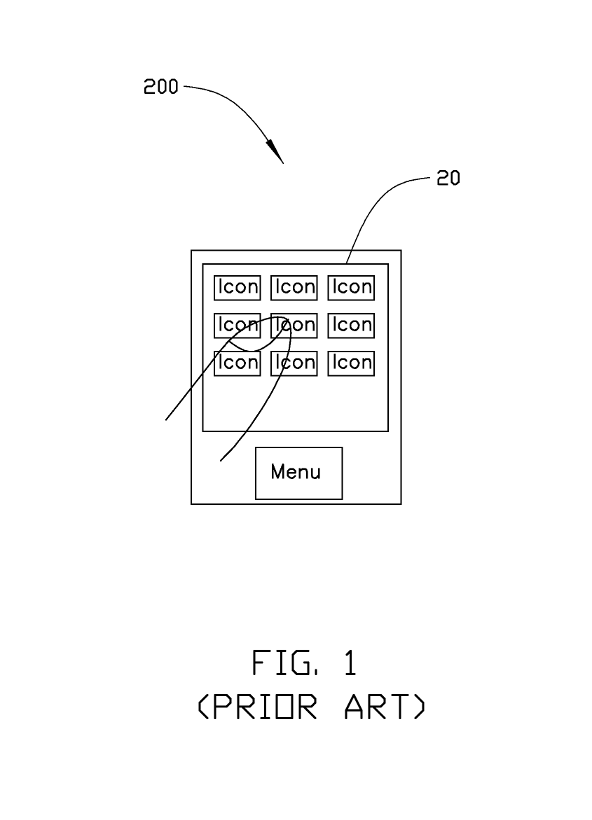

FIG. 2 is a schematic view of one embodiment of an electronic device.

FIG. 3 is a flow chart of inputting an arranging command by a touch panel of one embodiment.

FIG. 4 is a schematic view of inputting an arranging command by a gravity sensor of one embodiment.

FIG. 5 is a schematic view of inputting an arranging command by a gravity sensor of another embodiment.

FIG. 6 is a schematic view of inputting an arranging command by a gravity sensor of another embodiment.

FIG. 7 is a schematic view of inputting an arranging command by an audio sensor of one embodiment.

FIG. 8 is a schematic view of inputting an arranging command by an audio sensor of another embodiment.

FIG. 9 is a flow chart of inputting an arranging command by a single arranging button of one embodiment.

FIG. 10 is a schematic view of inputting an arranging command by a left side arranging button of one embodiment.

FIG. 11 is a schematic view of inputting an arranging command by a right side arranging button of one embodiment.

FIG. 12 is a flow chart of arranging shortcuts of the electronic device of one embodiment.

FIG. 13 is a flow chart of arranging functional bottoms of a file of the electronic device of one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

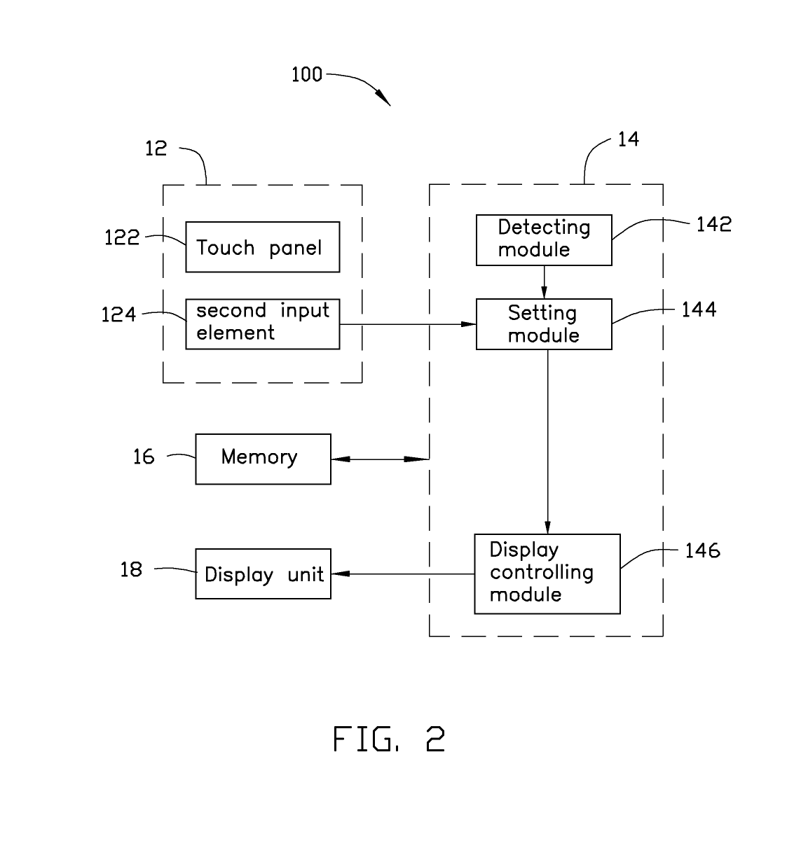

Referring to FIG. 2, an electronic device 100 of one embodiment is provided. The electronic device 100 is capable of rearranging functional icons of the electronic device 100. The functional icons mean icons which can be operated and activated directly by touching, such as shortcuts on desktop of the electronic device 100 or functional buttons of an application program. The electronic device 100 can be a smart phone, a pad, a notebook PC or other portable electronic device.

The electronic device 100 includes an input unit 12, a processor 14, a memory 16 and a display unit 18.

The input unit 12 includes a touch panel 122 and a second input element 124. The touch panel 122 can be a capacitive touch panel, a resistive touch panel, a pressure sensitive touch panel, an infrared touch panel, or combinations thereof. The second input element 124 can be a gravity sensor, an audio sensor, or at least one physical button. The input unit 12 inputs arranging commands, thus the functional icons on the display unit 18 can be located in a predeterminated area of the display unit 18. For example, the predeterminated area can be defined according to different habits and different requirements of different users, such as a left side of the display unit 18, a right side of the display unit 18, a top side of the display unit 18, or a lower side of the display unit 18.

The memory 16 stores different kinds of data, such as systems, different kinds of application programs, or data generated during using the electronic device 100. The memory 16 can be a smart media card, a secure digital card, a compact flash card, a multi media card, a memory stick, an extreme digital card, or a trans flash card.

The display unit 18 displays the functional icons.

The processor 14 includes a detecting module 142, a setting module 144, and a display controlling module 146.

The detecting module 142 detects a layout information of the functional icons on the display unit 18 and transmits the layout information to the setting module 144. The layout information includes quantity information of the functional icons and positional information of the functional icons.

The setting module 144 receives the arranging commands and the layout information, and inputs a rearranging command to the display controlling module 146 according to the arranging commands and the layout information.

The display controlling module 146 rearranges the functional icons according to the rearranging commands and controls the display unit 18 to display the functional icons as rearranged.

Methods for arranging the functional icons of the electronic device 100 of one embodiment includes steps of:
S10, inputting an arranging command;
S12, obtaining the layout information of the functional icons on the display unit 18; and
S14, rearranging the functional icons on a predetermined area of the display unit 18 according to the arranging command and the layout information of the functional icons.

In step S10, the arranging command can be inputted to the setting module 144 by the input unit 12.

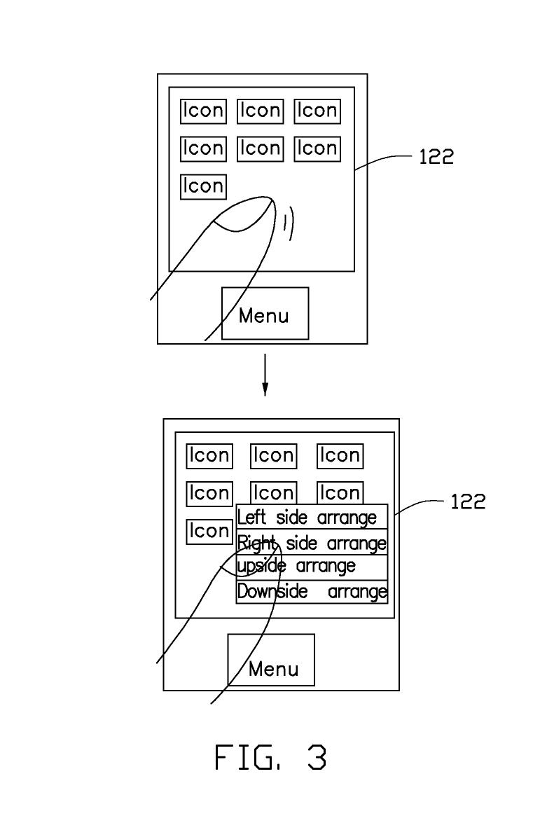

In one embodiment, the arranging command is inputted to the setting module 144 by the touch panel 122. Referring to FIG. 3, a command window having a number of arranging commands is opened by continuously pressing a blank area of the touch panel 122; and an arranging command of command window is chosen and transmitted to the setting module 144 by the touch panel 122.

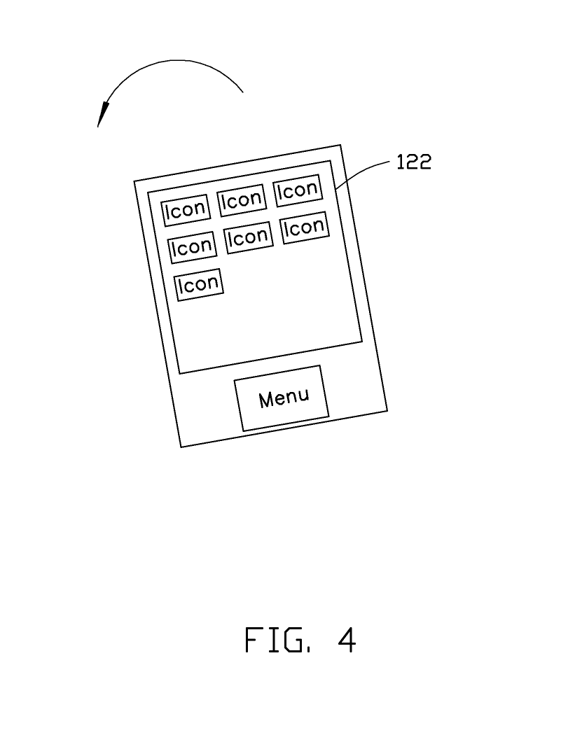

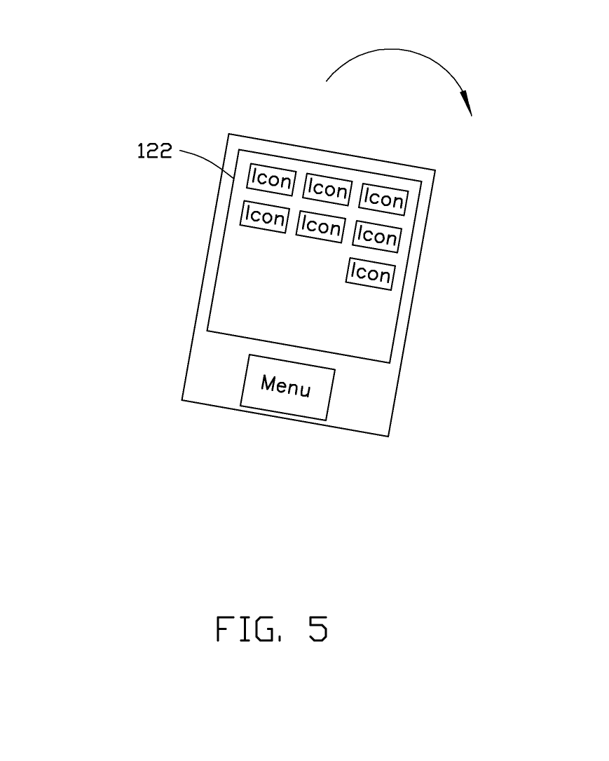

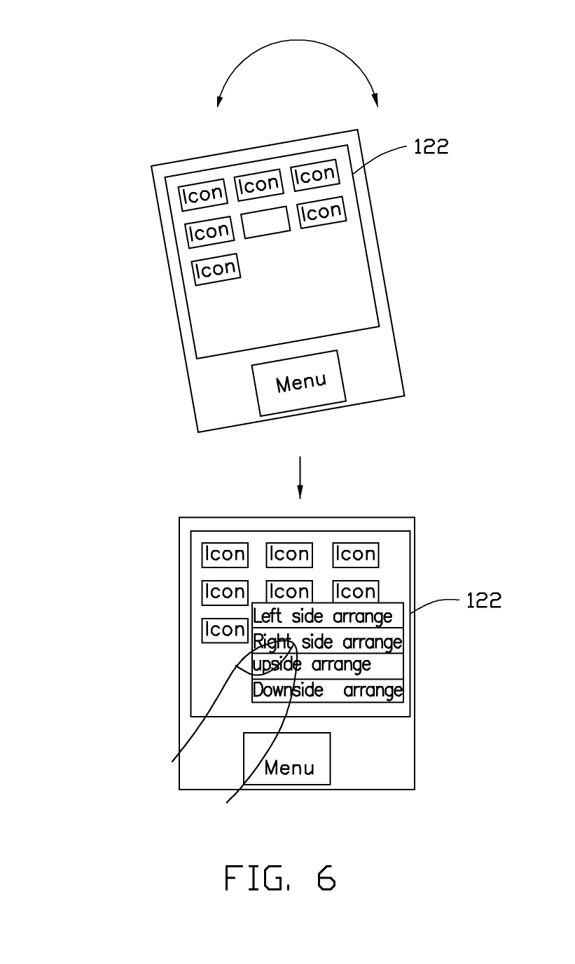

In another embodiment, the second input element 124 includes a gravity sensor, and the arranging command is inputted to the setting module 144 by the gravity sensor. Referring to FIG. 4, the electronic device 100 is inclined left side down, and that orientation is signaled by the gravity sensor; thus, a left side arranging command is transmitted to the setting module 144. Referring to FIG. 5, the electronic device 100 can be inclined right side down, and that orientation is signaled by the gravity sensor; thus, a right side arranging command is transmitted to the setting module 144. Referring to FIG. 6, the command window is opened by shaking the electronic device 100; and an arranging command of command window is chosen and transmitted to the setting module 144 by the touch panel 122.

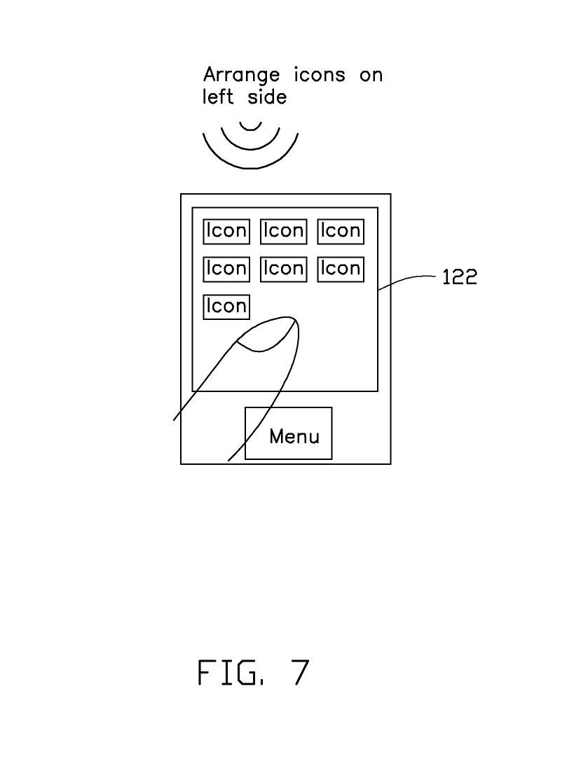

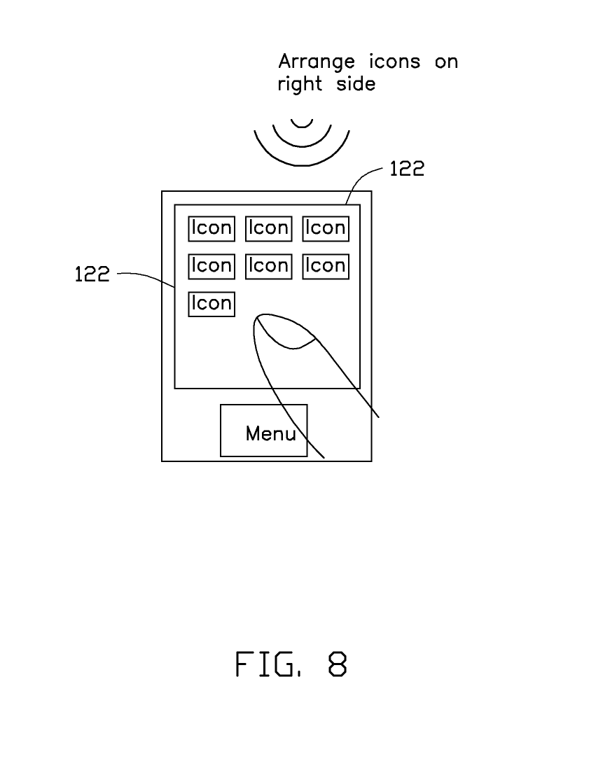

In some embodiments, the second input element 124 includes an audio sensor, and the arranging command is inputted to the setting module 144 by the audio sensor. Referring to FIG. 7, a spoken command “arrange icons on left side” is received by the audio sensor; thus, a left side arranging command is signaled to the setting module 144 by the audio sensor. Referring to FIG. 8, a spoken command of “arrange icons on right side” is received by the audio sensor; thus, a right side arranging command is signaled to the setting module 144 by the audio sensor.

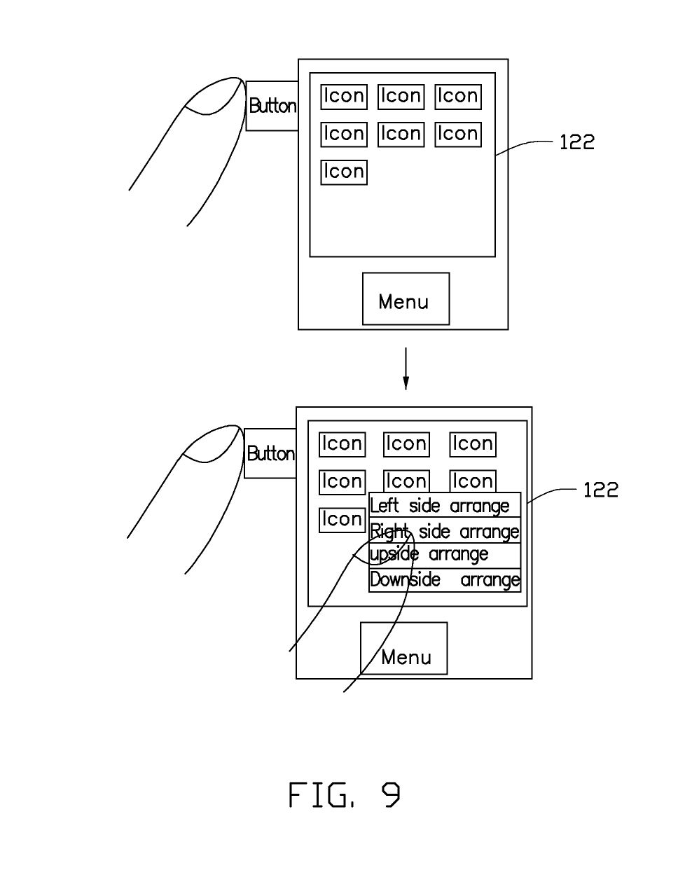

In some other embodiments, the second input element 124 includes a single arranging button, and the arranging command is inputted to the setting module 144 through the arranging button. Referring to FIG. 9, the command window is opened by pressing the arranging button; and an arranging command of the command window is chosen and transmitted to the setting module 144 by the touch panel 122.

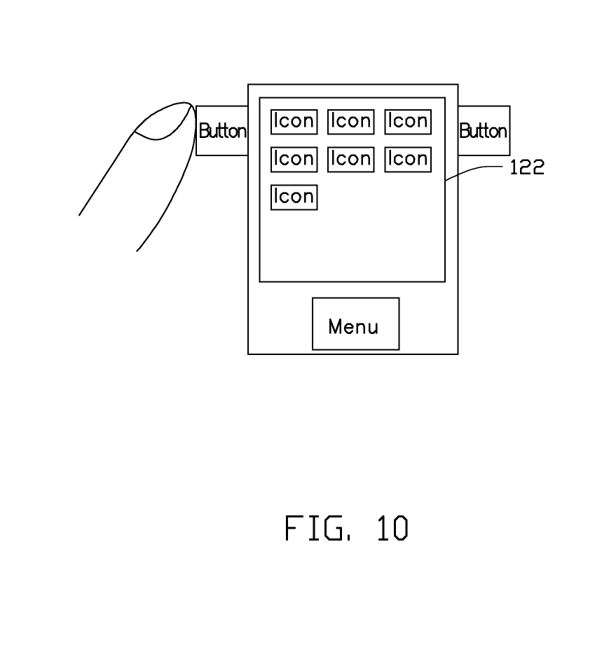

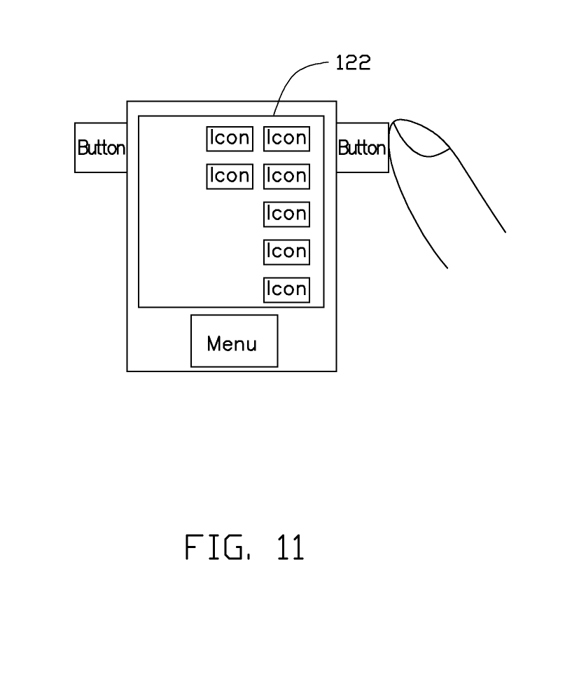

In some other embodiments, the second input element 124 includes a left side arranging button and a right side arranging button, and the arranging command is inputted to the setting module 144 through the left side arranging button and the right side arranging button directly. Referring to FIG. 10, a left side arranging command is directly inputted to the setting module 144 by pressing the left side button. Referring to FIG. 11, a right side arranging command is directly inputted to the setting module 144 by pressing the right side button.

In step S12, the layout information of the functional icons includes quantity information and positional information of the functional icons. In one embodiment, the layout information of the functional icons on the display unit 18 is timely obtained by the detecting module 142 and timely transmitted to the setting module 144. For example, the layout information of the functional icons is obtained by the detecting module 142 every second. In another embodiment, a detecting command is inputted to the detecting module 142 by the setting module 144 only after an arranging command has been given and a current layout information of the functional icons is detected by the detecting module 142 and fed back to the setting module 144.

In step S14, a rearranging command is inputted to the display controlling module 146 by the setting unit 144 according to the arranging command and the layout information. Thus, the functional icons are rearranged and displayed on the display unit 18 by the display controlling module 146.

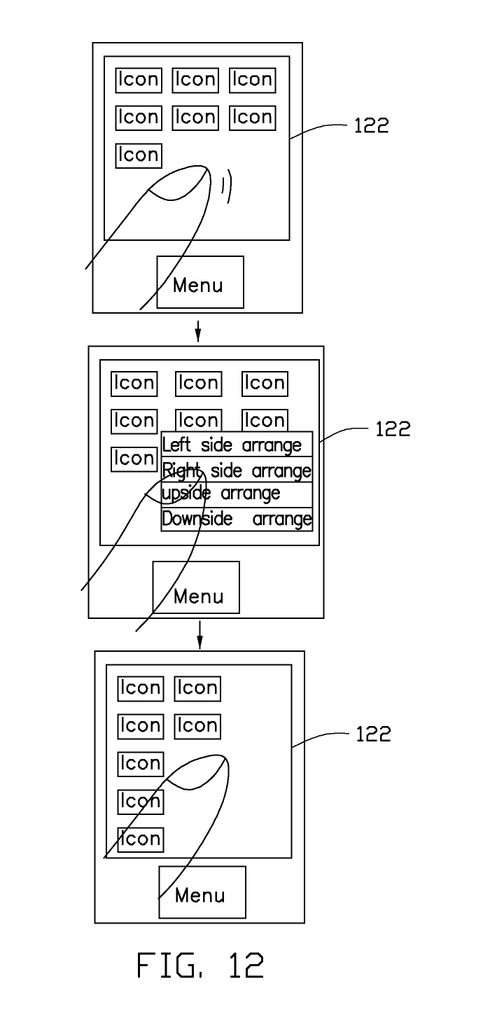

Referring to FIG. 12, the electronic device 100 is operated by a left hand of a user, and a method for arranging shortcuts on desktop of the electronic device 100 of one embodiment includes steps of: pressing a blank area of the touch panel 122 with the left thumb successively to open a command window, the command window includes a left side arranging command, a right side arranging command, a top side arranging command, and a lower side arranging command; inputting the left side arranging command to the setting module 144 by touch panel 122; obtaining an layout information of shortcuts by the detecting module 142 and transmitting the layout information of shortcuts to the setting module 144; inputting a left side rearranging command to the display controlling module 146 by the setting module 144 according to the left side arranging command and the layout information of shortcuts; and rearranging the shortcuts on the left side of the display unit 18.

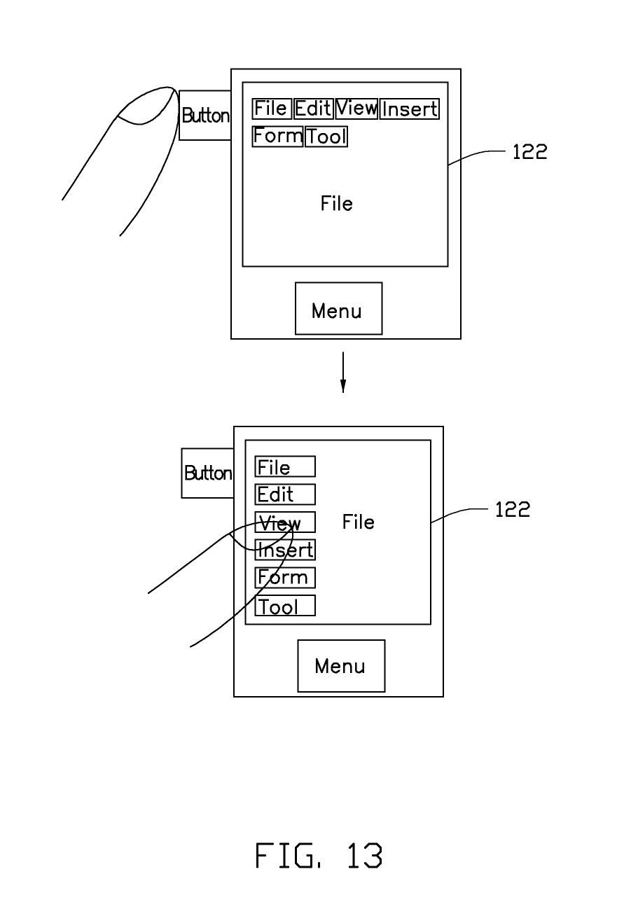

Referring to FIG. 13, the electronic device 100 is held and operated by a left hand of a user, and a method for arranging functional bottoms of a file on desktop of the electronic device 100 of another embodiment includes steps of: pressing a left side arranging button to input a left side arranging command to the setting module 144; transmitting a detecting command to the detecting module 142 after the arranging command is obtained by the setting module 144; obtaining an layout information of the functional bottoms of the file and transmitting the information of the functional bottoms of the file to the setting module 144; inputting a left side rearranging command to the display controlling module 146 by the setting module 144 according to the left side arranging command and the information of the functional bottoms of the file; and rearranging the functional bottoms of the file on the left side of the display unit 18 as required.

The method for arranging the functional icons of the electronic device of the present embodiment is simple, and the functional icons can be quickly rearranged to a side of the display unit. Thus, the electronic device is suitable for single hand operation and is more personalized.

The above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

1. An electronic device comprising:
an input unit, a processor, a memory and a display unit; wherein the input unit is adapted to input arranging commands to the processor and comprises a touch panel;
the processor comprises a detecting module, a setting module, and a display controlling module;
the detecting module is adapted to detect layout information of functional icons on the display unit and to transmit the layout information of the functional icons to the setting module;
the setting module is adapted to receive the arranging commands and the layout information of the functional icons, and to input a rearranging command to the display controlling module; and
the display controlling module is adapted to rearrange the functional icons according to the rearranging commands and to control the display unit to display rearranged functional icons.

2. The electronic device as claimed in claim 1, wherein the input unit comprises a gravity sensor, an audio sensor, or at least one physical button.

3. The electronic device as claimed in claim 1, wherein the touch panel is selected from the group consisting of a multi-touch capacitive touch panel, a multi-touch resistive touch panel, a pressure sensitive touch panel, an infrared touch panel, and a combination thereof.

4. The electronic device as claimed in claim 1, wherein the memory is configured to storage different kinds of digital data of the electronic device.

5. The electronic device as claimed in claim 1, wherein the memory is selected from the group consisting of a smart media card, secure digital cards, compact flash cards, multi media cards, memory sticks, extreme digital cards, and trans flash cards.

6. A method for arranging functional icons of an electronic device, comprising steps of:
providing an electronic device comprising an input unit, a processor, a memory and a display unit; wherein the input unit is adapted to input arranging commands to the processor and comprises a touch panel; the processor comprises a detecting module, a setting module, and a display controlling module; the detecting module is adapted to detect layout information of functional icons on the display unit and to transmit the layout information of the functional icons to the setting module; the setting module is adapted to receive the arranging commands and layout information of the functional icons, and to input a rearranging command to the display controlling module; and the display controlling module is adapted to rearrange the functional icons according to the rearranging commands and to control the display unit to display rearranged functional icons;
inputting an arranging command by the input unit;
obtaining the layout information of the functional icons by the detecting module; and
rearranging the functional icons on a predestinate area of the display unit according to the arranging command and the layout information of the functional icons.

7. The method of claim 6, wherein the step of inputting the arranging command comprises sub-steps of:
opening a command window having a plurality of arranging commands by successively pressing a blank area of the touch panel; and
choosing the arranging command of command window by the touch panel.

8. The method of claim 6, wherein the input unit comprises a gravity sensor, and step of inputting the arranging command comprises sub-steps of:
opening a command window having a plurality of arranging commands by swinging the electronic device; and
choosing the arranging command of command window by the touch panel.

9. The method of claim 6, wherein the input unit comprises a gravity sensor, and step of inputting the arranging command comprises sub-steps of:
inclining the electronic device to a left side of the electronic device; and
inputting a left side arranging command by the gravity sensor.

10. The method of claim 6, wherein the input unit comprises a gravity sensor, and step of inputting the arranging command comprises sub-steps of:
inclining the electronic device to a right side of the electronic device; and
inputting a right side arranging command by the gravity sensor.

11. The method of claim 6, wherein the input unit comprises an audio sensor, and step of inputting the arranging command is carried out by inputting an audio signal to the audio sensor.

12. The method of claim 6, wherein the input unit comprises a single arranging button, and step of inputting the arranging command comprises sub-steps of:
opening a command window having a plurality of arranging commands by pressing the arranging button; and
choosing the arranging command of command window by the touch panel.

13. The method of claim 6, wherein the input unit comprises a right side arranging button, and a left side arranging command button, and step of inputting the arranging command is carried out by pressing the right side arranging button or the left side arranging command button.

14. The method of claim 6, wherein the predestinate area of the display unit is selected from the group consisting of a left side of the display unit, a right side of the display unit, a upside of the display unit, and a downside of the display unit.

15. The method of claim 6, wherein the layout information of the functional icons comprises quantity information of the functional icons and position information of the functional icons.

16. The method of claim 6, wherein the layout information of the functional icons is timely obtained by the detecting module and timely transmitted to the setting module.

17. The method of claim 6, wherein the step of obtaining the layout information of the functional icons is carried out by sub-steps of:
inputting a detecting command to the detecting module by the setting module after the arranging command is obtained; and
obtaining the layout information of the functional icons by the detecting module.
